(19) United States
(12) Patent Application Publication
(10) Pub. No.: US 2017/0222311 A1
(43) Pub. Date: Aug. 3, 2017

(54) VEHICLE SENSING SYSTEM WITH RADAR ANTENNA RADOME

(71) Applicant: MAGNA ELECTRONICS INC., Auburn Hills, MI (US)

(72) Inventors: Holger Hess, Aschaffenburg (DE); Joern Ihlenburg, Berlin (DE)

(21) Appl. No.: 15/420,238

(22) Filed: Jan. 31, 2017

Related U.S. Application Data
(60) Provisional application No. 62/289,441, filed on Feb. 1, 2016.

(51) Int. Cl. H01Q 1/42; H01Q 1/32; G01S 13/93

(52) U.S. Cl. CPC H01Q 1/42; G01S 13/931; H01Q 1/3283; G01S 2007/027

(57) ABSTRACT

A sensing system for a vehicle includes a radar sensor unit disposed at the vehicle so as to sense exterior of the vehicle. The radar sensor unit includes a radar housing that houses a radar sensor and associated circuitry. The radar sensor unit includes an outer element configured to correspond with an outer surface of a component of the vehicle at location where the radar sensor unit is disposed. The outer element includes a radome material and reduces attenuation of electromagnetic signals emitted by and received by the radar sensor as compared to attenuation of electromagnetic signals of the component of the vehicle.

### CROSS REFERENCE TO RELATED APPLICATION

The present application claims the filing benefits of U.S. provisional application Ser. No. 62/289,441, filed Feb. 1, 2016, which is hereby incorporated herein by reference in its entirety.

### FIELD OF THE INVENTION

The present invention relates generally to a vehicle sensing system for a vehicle and, more particularly, to a vehicle sensing system that utilizes one or more radar sensors at a vehicle.

### BACKGROUND OF THE INVENTION

Use of imaging and radar sensors in vehicle imaging systems is common and known. Examples of such known systems are described in U.S. Pat. Nos. 8,013,780 and 5,949,331, which are hereby incorporated herein by reference in their entireties.

### SUMMARY OF THE INVENTION

The present invention provides a driver assistance system or sensing system for a vehicle that utilizes one or more radar sensors to sense regions exterior of the vehicle, with the radar sensor unit comprising a radar sensor and an outer vehicle portion (such as a vehicle emblem or fascia element or the like), and with the outer vehicle portion comprising a radome material (that provides a structural, weatherproof enclosure) to protect the radar sensor while minimally attenuating the electromagnetic signals transmitted by and sensed or received by the radar sensor. The radar sensor unit thus provides a reduced number of parts or elements to ease assembly of the sensor unit at the vehicle, while providing enhanced performance of the radar sensor.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a sensing system that incorporates a radar sensor in accordance with the present invention;

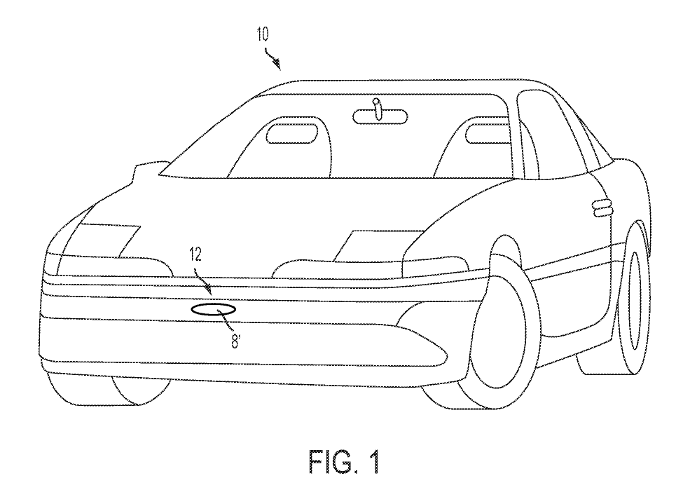

FIG. 2 is a sectional view showing a vehicle front grill having a radar unit assembled therewithin and directed generally horizontally forward, having a front fascia and a radar unit front radome within a gap between the fascia and radar unit; and

FIG. 3 is a sectional view showing a vehicle front grill having a radar unit directed generally horizontally forward, and having a front radome incorporating the outer fascia in accordance with the present invention.

### DESCRIPTION OF THE PREFERRED EMBODIMENTS

A vehicle sensing system and/or driver assist system and/or object detection system and/or alert system operates to capture image data and/or sensing data exterior of the vehicle and may process the captured data to display images and to detect objects at or near the vehicle and in the predicted path of the vehicle, such as to assist a driver of the vehicle in maneuvering the vehicle in a forward or rearward direction. The vision system includes a processor that is operable to receive image data and/or sensing data from one or more cameras/sensors and provide an output, such as a display output to a display device for displaying images representative of the captured image data. Optionally, the vision system may provide display, such as a rearview display or a top down or bird's eye or surround view display or the like.

Referring now to the drawings and the illustrative embodiments depicted therein, a vehicle 10 includes an driver assistance system or sensing system 12 that includes at least one radar sensor unit, such as a forward facing radar sensor unit 8 (and the system may optionally include multiple exterior facing sensors, such as cameras or other sensors, such as a rearwardly facing sensor at the rear of the vehicle, and a sidewardly/rearwardly facing sensor at respective sides of the vehicle), which sense regions exterior of the vehicle. The sensing system 12 includes a control or electronic control unit (ECU) or processor that is operable to process data captured by the sensor or sensors and may detect objects or the like. The data transfer or signal communication from the sensor to the ECU may comprise any suitable data or communication link, such as a vehicle network bus or the like of the equipped vehicle.

Front radars are typically built into a vehicle front bumper or front grill. Many of them are integrated into the front grill or bumper, but customers want to have these radars concealed behind the bumper fascia, front grill, or vehicle emblem. Sidewardly directed vehicle radar sensors are nowadays also installed hidden behind the vehicle bumper fascia or integrated into side mirror housings or mirror foot housings behind a fascia. In such concealed installations, the radar sensor has to transmit and receive through an additional element (such as the bumper fascia or vehicle emblem or mirror housing or the like). The outer fascia or emblem element reflects, absorbs and warps the transmitted and received radiation, which leads to a reduced radar performance when such radars are installed at the vehicle.

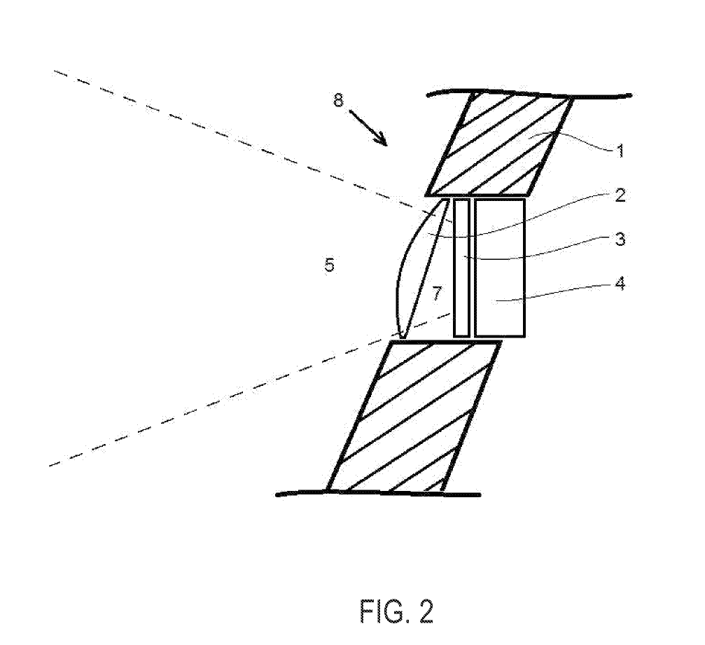

FIG. 2 shows a vehicle front grill 1 with having a radar unit 8 assembled within the grill 1 (such as at an aperture established through the grill) and directed horizontally forward through the aperture (so as to have a sensing field 5 generally forward of the vehicle), with a frontal fascia element 2 and a radar unit front radome 3 with an air gap 7 at the aperture in the grill, and with a radar sensor and rear housing 4 attached behind the radome 3 and holding the radar electronics. The radome 3 provides a protective material that minimally attenuates the electromagnetic signals transmitted by and sensed or received by the radar sensor. However, the radome 3 is an additional element disposed between the outer vehicle element 2 and the radar emitter/sensor housing 4. Such a configuration for a radar sensor unit at the vehicle grill thus has multiple components in order to provide a radome and an outer fascia element (that generally conceals the radar sensor from view), with the outer fascia element providing an outer viewable surface that generally corresponds with the outer surface of the grill (or other vehicle component) at which the radar sensor is disposed.

The present invention combines the vehicle emblem, bumper fascia or side mirror fascia with the antenna radome so as to provide a single element or piece and eliminating one of the cover elements (and thus reducing or eliminating the attenuation of the electromagnetic signals emitted by and received by the radar). The radar sensing unit emits radio waves (radio waves are a type of electromagnetic radiation with wavelengths in the electromagnetic spectrum longer than infrared light) and receives radio waves and processes the received signals to determine the presence of an object in the sensing region or field of the radar sensing unit. The radio frequency Radar waves have bands starting from about 30 Megahertz up to about 130 Gigahertz. Typically, for automotive radar systems, the frequencies used are 24 GHz, 46 GHz, 60 GHz, 76 Ghz and/or 96 Ghz. The provision of the antenna radome as part of the outer cover element reduces the parts or components of the radar sensor and provides enhanced performance of the sensor.

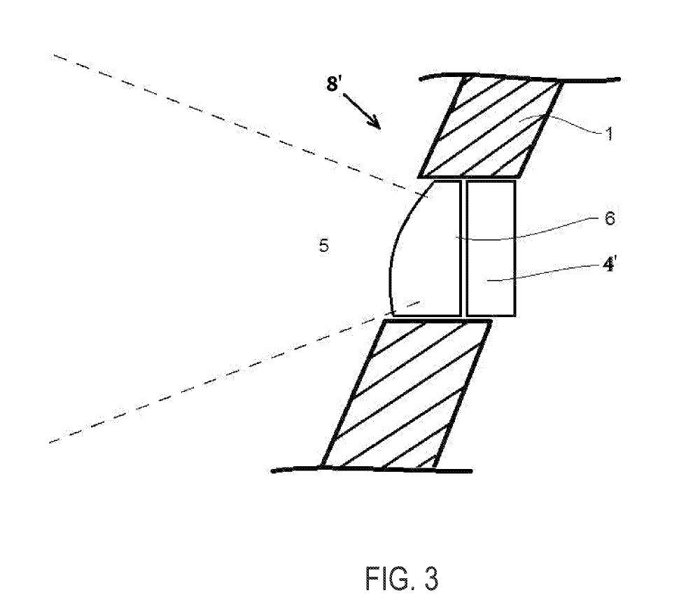

For example, and such as shown in FIG. 3, the vehicle front grill 1 has an aperture formed therethrough, with the assembled radar unit 8′ according to the present invention disposed at the aperture and directed generally horizontally forward (so as to sense in the direction and region 5 forward of the vehicle). The radar unit 8′ includes a front radome incorporated in the outer fascia element 6 and a radar rear housing 4′ (holding the radar electronics, including emitter and receiver/sensor) attached at and behind the radome/fascia element, without an air gap between the radome/fascia element and the radar housing. The outer element 6 may be configured to generally correspond with the outer vehicle element or component (such as a vehicle emblem or fascia or grill or mirror housing or the like), such as by utilizing aspects of the systems described in U.S. Pat. No. 8,698,894 and/or U.S. Publication No. US-2013-0215271, which are hereby incorporated herein by reference in their entireties).

The present invention thus provides an enhanced radar sensor and sensing system since it will reduce the number of absorbing, reflecting, and warping elements in front of the emitting and receiving radar antenna. This leads to enhanced radar performance due to reduced attenuation and disturbances. Disadvantage influences due to assembly variances of the gap between the emblem or bumper fascia are also reduced or obviated. The installation of the radar sensor unit or module of the present invention into a vehicle is also easier since the radar and the vehicle emblem may optionally be mounted as a single unit or module at a common or single bracket. Likewise, when assembling the radar sensor of the present invention at a side mirror foot or mirror housing, it will be beneficial to combine the vehicle/mirror fascia with the antenna radome so that the radar sensor and fascia or outer element may be mounted as a single unit or module at the mirror casing or vehicle element.

The sensing system may utilize aspects of the systems described in U.S. Pat. Nos. 8,027,029; 8,013,780; 6,825,455; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or International Publication No. WO 2011/090484 and/or U.S. Publication No. US-2010-0245066 and/or U.S. provisional applications, Ser. No. 62/375,161, filed Aug. 15, 2016, Ser. No. 62/361,586, filed Jul. 13, 2016, Ser. No. 62/359,913, filed Jul. 8, 2016, Ser. No. 62/349,874, filed Jun. 14, 2016, Ser. No. 62/330,557, filed May 2, 2016, Ser. No. 62/313,279, filed Mar. 25, 2016, and/or Ser. No. 62/303,546, filed Mar. 4, 2016, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A radar sensing system for a vehicle, said radar sensing system comprising:
a radar sensor unit disposed at the vehicle so as to sense exterior of the vehicle;
wherein said radar sensor unit comprises a radar housing that houses a radar sensor and associated circuitry;
wherein said radar sensor unit comprises an outer element configured to correspond with an outer surface of a component of the vehicle at a location where said radar sensor unit is disposed at the vehicle; and
wherein said outer element comprises a radome material.

2. The radar sensing system of claim 1, wherein said radar sensor unit comprises a unitary module that is configured to be disposed at an aperture through the vehicle component.

3. The radar sensing system of claim 2, wherein the vehicle component comprises a front bumper of the vehicle.

4. The radar sensing system of claim 2, wherein the vehicle component comprises a front grill of the vehicle.

5. The radar sensing system of claim 2, wherein the vehicle component comprises a rear bumper of the vehicle.

6. The radar sensing system of claim 2, wherein the vehicle component comprises a side panel of the vehicle.

7. The radar sensing system of claim 2, wherein the vehicle component comprises a housing of an exterior mirror of the vehicle.

8. The radar sensing system of claim 1, wherein said outer element reduces attenuation of electromagnetic signals emitted by and received by said radar sensor as compared to attenuation of electromagnetic signals of the component of the vehicle.

9. The radar sensing system of claim 1, wherein said radar sensor comprises a radar emitter that emits electromagnetic signals and a radar receiver that receives electromagnetic signals.

10. The radar sensing system of claim 1, wherein said outer element is incorporated in an outer fascia element of the vehicle.

11. The radar sensing system of claim 1, wherein said radar housing is attached at said outer element without an air gap between said outer element and said radar housing.

12. A radar sensing system for a vehicle, said radar sensing system comprising:
a radar sensor unit disposed at the vehicle so as to sense exterior of the vehicle;
wherein said radar sensor unit comprises a radar housing that houses a radar sensor and associated circuitry;
wherein said radar sensor unit comprises an outer element configured to correspond with an outer surface of a component of the vehicle at a location where said radar sensor unit is disposed at the vehicle;
wherein said outer element comprises a radome material;
wherein said radar sensor unit is configured to be disposed at an aperture through the vehicle component; and
wherein the vehicle component comprises an outer fascia element of the vehicle and wherein said outer element is incorporated in the outer fascia element of the vehicle.

13. The radar sensing system of claim 12, wherein the vehicle component comprises a front bumper of the vehicle.

14. The radar sensing system of claim 12, wherein the vehicle component comprises a front grill of the vehicle.

15. The radar sensing system of claim 12, wherein the vehicle component comprises a rear bumper of the vehicle.

16. The radar sensing system of claim 12, wherein the vehicle component comprises a side panel of the vehicle.

17. The radar sensing system of claim 12, wherein said outer element reduces attenuation of electromagnetic signals emitted by and received by said radar sensor as compared to attenuation of electromagnetic signals of the component of the vehicle.

18. The radar sensing system of claim 12, wherein said radar sensor comprises a radar emitter that emits electromagnetic signals and a radar receiver that receives electromagnetic signals.

19. A radar sensing system for a vehicle, said radar sensing system comprising:
a radar sensor unit disposed at the vehicle so as to sense exterior of the vehicle;
wherein said radar sensor unit comprises a unitary module that is configured to be disposed at an aperture through a component of the vehicle;
wherein said radar sensor unit comprises a radar housing that houses a radar sensor and associated circuitry;
wherein said radar sensor comprises a radar emitter that emits electromagnetic signals and a radar receiver that receives electromagnetic signals;
wherein said radar sensor unit comprises an outer element configured to correspond with an outer surface of the vehicle component at a location where said radar sensor unit is disposed at the vehicle;
wherein said outer element comprises a radome material; and
wherein said outer element reduces attenuation of electromagnetic signals emitted by and received by said radar sensor as compared to attenuation of electromagnetic signals of the component of the vehicle.

20. The radar sensing system of claim 19, wherein said radar housing is attached at said outer element without an air gap between said outer element and said radar housing.
